(19) United States
(12) Patent Application Publication
(10) Pub. No.: US 2020/0060935 A1
(43) Pub. Date: Feb. 27, 2020

(54) PILL CUTTER DEVICE

(71) Applicant: Hind Alshear, Burlington (CA)

(72) Inventor: Hind Alshear, Burlington (CA)

(21) Appl. No.: 16/396,945

(22) Filed: Apr. 29, 2019

Related U.S. Application Data
(60) Provisional application No. 62/637,963, filed on Mar. 2, 2018.

(51) Int. Cl. A61J 7/00

(52) U.S. Cl. CPC A61J 7/0007; B26D 3/30; A61J 7/0084

(57) ABSTRACT

A pill cutter device for simultaneously cutting one or more pills and a method of using the same. The pill cutter device includes a lower housing having a top wall and a pair of rails that extends longitudinally along the top wall and are movable laterally toward and away from each other. A pill holder is engaged on each rail and is slidable longitudinally therealong towards and away from a retaining wall. Each rail includes a resilient pad and pills placed on the top wall are moved by the rails and pill holder into alignment with the longitudinal axis of the device. The pills are captured and held immobile between the two resilient pads, the pill holders, and the retaining wall. An upper housing is movable toward the lower housing and downward movement thereof brings a longitudinally aligned cutter blade into contact with the pills to cut the same.

### CROSS REFERENCE TO RELATED APPLICATIONS

This application claims the benefit of U.S. Provisional Application Ser. No. 62/637,963 filed on Mar. 2, 2018, the entire disclosure of which is incorporated herein by reference.

### TECHNICAL FIELD

The present disclosure relates generally to the field of medical devices. More specifically, the disclosure is directed to a cutting device for solid forms of medication such as pills and tablets. In particular, the present disclosure relates to a cutter device that is configured to be able to cut multiple pills or tablets at the same time by moving a lid of the device from an open position to a closed position toward a base to bring a blade in the lid in contact with the pills retained in the base.

### BACKGROUND

### Background Information

Pharmaceutical dosages of drugs may be taken in a variety of different ways including medications that are in a solid state and taken orally, or medications that are in a liquid state and are taken orally or by injection. One suitable way of delivering pharmaceutical drugs or medication in a solid state is by molding or compressing a powered form of the medication into a pill, a tablet, or a capsule. Typically, the terms “'pill” and “tablet” are used to describe molded or compressed doses of medication that come in a wide variety of different shapes and size. The pills and tablets may be flat and round, oval, square, elongated, triangular, and even tear shaped, for example. The term “capsule” is used to describe a typically oval component that is filled with a powder or jellylike form of the medication. In some instances, it is needful to cut pills or tablets into smaller segments in order to reduce the size of the dose to be taken by a patient. Cutting pills or tablets into segments that are of substantially uniform size without crushing or crumbling off some of the compressed or molded material can be quite difficult, particularly if the pill or tablet in question is of a relatively small size. Cutting irregularly shaped segments or crushing or crumbling material off the pill or tablet during cutting means that the dosage of medication contained in the end product varies from segment to segment. If the patient regularly has to take a smaller dose of medication than a full pill or tablet will deliver, it is helpful if multiple pills or tablets are able to be cut at the same time. Cutting capsules into segments is not advisable since the powdered or jellied form of the medication will simply spill out of the shell of the capsule. It will be understood that the terms “pill” and “tablet” may be used interchangeably in this document to refer to any unit of molded or compressed medication.

A number of pill cutter devices have been proposed in the prior art. Some of these cutter devices are configured to cut a single pill at a time while others are configured to cut multiple pills at one time. Suhr (US 2009/0183373), for example, discloses a pill cutting device that has a base with a lid pivotally engaged therewith. A holding wall and adjustable pill retaining members extend outwardly from the upper surface of the base. The holding wall and pill retaining members are V-shaped when viewed from above. A slot is defined in the upper surface of the base and passes through the apices of the V-shaped holding wall and pill retaining members. A single pill will be placed in the pill cutting area. A longitudinally oriented blade extends downwardly from the underside of the lid. The blade is positioned to cut through the pill retained between the holding wall and pill retaining members. The blade passes at least partially into the slot.

Ferraro (US2016/0051448) discloses a pill cutter comprising a lower housing and an upper housing that are pivotally engaged with each other. The lower housing includes a pill holder having a recessed area into which a single pill is placed. Support arms provided on the lower housing are angled inwardly into a suitable position to hold the pill to be cut in a set position. The upper housing includes a cutting blade that is aligned with the pill holder when the upper housing is pivoted toward the lower housing. The cutting blade is configured to cut the pill into multiple segments of uniform size. The pill holder includes a chamber that receives the cut pieces. One of the disadvantages of the Ferraro device is that it can only cut a single pill at a time.

Eric (U.S. Pat. No. 6,557,945) discloses a tablet cutting assembly comprising a base including a tablet supporting assembly with a variety of differently sized and shaped slots, each slot being configured to receive a particular size and shape of tablet therein. A tablet cutting assembly is secured to the base and is movable into a first position to permit a tablet to be inserted into the appropriate slot in the table supporting assembly. The tablet cutting assembly is movable into a second position to cut the tablet that is supported in the tablet supporting assembly. The tablet cutting assembly includes a blade holder having a blade. Supports and a cam follower also form part of the tablet cutting assembly. The supports hold the blade holder within the table cutting assembly. The cam follower urges the tablet cutting assembly from the first position to the second position. In the second position, the blade cuts the tablet held in the table supporting assembly. If the slots in the tablet supporting assembly are all different shapes and sizes, then Eric's device will typically be utilized to only cut one tablet at a time. In other instances, all of the slots in the tablet supporting assembly may be identical in shape and size. In this latter instance, Eric's device may be used to cut multiple tablets at the same time. The disadvantage of the Eric device is that the tablet supporting assembly includes tablet holding areas that are of a specific or defined shape. This limits the device in that it is only capable of cutting very specifically shaped pills.

Smith (U.S. Pat. No. 9,314,405) discloses a pill cutter for cutting multiple pills at the same time. The pill cutter includes a pill cutting bed having pill retainers thereon. The pill retainers are movable to hold a plurality of pills between them. A top portion of the housing is pivotally engaged with the pill cutting bed and a cutting blade extends downwardly from an interior surface of the top portion of the housing. When the top portion of the housing is moved downwardly toward the pill cutting bed, the cutting blade will cut through the multiple pills that are engaged between the pill retainers.

Sundt, (U.S. Pat. No. 9,827,165) discloses a device that is capable of cutting multiple pills at the same time. The device includes a base with a flat top for loading pills. Spring-loaded alignment bars are movable so as to align and hold multiple pills or tablets in a straight line. A cover member is provided that includes a cutting blade covered by a spring-biased blade guard. When the cover member is pushed downwardly toward the base, the blade guard is retracted and the blade cuts the multiple pills substantially simultaneously. In the Sundt device, the cover member brings the blade down vertically onto the pills. The problem with this arrangement is that contacting the pills with a blade in this manner tends to lead to the pills being partially crushed by the blade as it cuts. Obviously, crushing the pills is problematic in that the smaller segments of the pills may be of inconsistent size and therefore the dose of medication delivered by the pills will be inadvertently varied. This can have health consequences for the patient. Additionally, crushing the pills causes overall loss of the medication that has been prescribed to the patient.

### SUMMARY

A pill cutter device for cutting one or more pills and a method of using the same. The pill cutter device is able to cut multiple pills at substantially the same time. The pill cutter device includes a lower housing having a top wall and a pair of rails that extends longitudinally along the top wall and are movable laterally toward and away from each other. A pill holder is engaged on each rail and is slidable longitudinally therealong towards and away from a retaining wall. Each rail includes a resilient pad and pills placed on the top wall are moved by the rails and pill holder into alignment with the longitudinal axis of the device. The pills are captured and held immobile between the two resilient pads, the pill holders, and the retaining wall. An upper housing is movable toward the lower housing and downward movement thereof brings a longitudinally aligned cutter blade into contact with the pills and the blade cuts through the pills and is received least partially in a slot located along the longitudinal axis of the device.

The pill cutter device of the present disclosure is able to cut pills and tablets, no matter the shape or size thereof. The pill cutter device is therefore able to cut flat, round, square, elongated, oval, triangular, and tear-shaped pills, for example. When the pills are oriented appropriately within the pill cutter device and are substantially immobilized therein, the pill cutter's blade will cut the pills exactly in half. The pill cutter device has two rails that are moved in unison inwardly toward each other and have resilient surfaces that aid in capturing the pills to be cut between the rails. Because the rails move in unison to capture the pills between them, the pills are always aligned directly under the blade. The blade is located along the midline of the pills to be cut and the blade will move downwardly at a location equidistant from both rails. As a result, the blade will always cut the pills exactly down the middle provided the pills where correctly oriented before cutting began. The pill cutter device is configured to bring the blade thereof into contact with the pills at an angle instead of at right angles thereto as was the case with a number of PRIOR ART pill cutters. The advantage of the arrangement of the blade within the presently disclosed pill cutter device is that there is substantially less tendency of the blade to crush the pills it is cutting than was the case in previously known devices.

In one aspect, an exemplary embodiment of the present disclosure may provide a pill cutter device for simultaneously cutting one or more pills comprising a lower housing having a top wall adapted to receive one or more pills thereon; at least one rail extending longitudinally along the top wall; said at least one rail being laterally movable across the top wall in one of a first lateral direction and a second lateral direction; and a pill holder engaged on the at least one rail, said pill holder being longitudinally movable along the at least one rail.

In one example, the pill cutter device includes a retaining wall provided on the top wall, said retaining wall being oriented at right angles to a longitudinal axis of the top wall, wherein the pill holder and retaining wall are adapted to retain the one or more pills longitudinally between them. In one example, the at least one rail comprises a first ratchet rail and a second ratchet rail; and wherein the pill cutter device further comprises a linkage extending between the first ratchet rail and the second ratchet rail, and wherein the linkage causes the first ratchet rail and the second ratchet rail to move in unison. The linkage causes the first ratchet rail and the second ratchet rail to move laterally in unison in one of a first direction toward each other and in a second direction away from each other. In some examples, the at least one rail includes a resilient pad provided on a pill contacting surface thereof.

In one embodiment, the at least one rail includes a ratchet surface including one or more teeth; and where the pill holder includes at least one tooth that selectively engages the one or more teeth or the ratchet surface and resists longitudinal movement of the pill holder along the at least one rail. The pill cutter device further comprises an upper housing pivotally engaged with the lower housing; and wherein the upper housing includes a blade extending downwardly from a top wall of the upper housing; and wherein the blade is oriented parallel to a longitudinal axis of the lower housing. The pill cutter device further comprises a slit defined in top wall of the lower housing; wherein the slit is positioned to align with the blade and to receive at least a portion of the blade therein during a cutting procedure. In one embodiment, the pill cutter device further includes a rail lock assembly that is movable between a locked position and an unlocked position; and when the rail lock assembly is in the locked position, lateral movement of the at least one rail is prevented; and when the rail lock assembly is in the unlocked position, lateral movement of the at least one rail is possible. A cut-pill container is removably engaged with the lower housing, wherein the container has an upper end that is flush with or located a distance vertically below the top wall of the lower housing.

In one example, the pill cutter device includes a brush tool detachably engaged with the pill cutter device; said brush tool being selectively engageable with the pill holder to move the pill holder longitudinally along the at least one rail. In one example, the pill cutter device includes one or more slots defined in the top wall of the lower housing; and wherein at least a portion of the at least one rail extends through the one or more slots. The one or more slots are laterally-oriented on the top wall; and wherein the one or more slots limit the lateral travel of the at least one rail across the top wall. The at least one rail includes a first ratchet rail located above an upper surface of the top wall of the lower housing; a first slide rail located below a lower surface of the top wall of the lower housing; wherein the first ratchet rail and first slide rail are operatively engaged with each other. In one example, the at least one rail further comprises a second ratchet rail located above the upper surface of the top wall of the lower housing and spaced laterally from the first ratchet rail; and a second slide rail located below a lower surface of the top wall of the lower housing; wherein the second ratchet rail and second slide rail are operatively engaged with each other; and the second slide rail is laterally spaced from the first slide rail. The pill cutter device further includes at least one rotatable cam operatively connecting the first slide rail to the second slide rail. The at least one rotatable cam causes the first ratchet rail and second ratchet rail to move in unison.

In another aspect, an exemplary embodiment of the present disclosure may provide a method of cutting one or more pills into smaller pill segments comprising placing one or more pills onto a top wall of a lower housing of a pill cutter device; moving at least one rail across the top wall to contact the one or more pills; immobilizing the one or more pills, wherein the immobilizing includes contacting the one or more pills with a resilient pad provided on the at least one rail; aligning a blade on an upper housing of the pill cutter device with a centerline of the one or more pills; bringing the blade into contact with the one or more pills; and cutting the one or more pills into smaller pill segments.

In one aspect, the method includes pivoting the upper housing downwardly toward the lower housing; orienting the blade at an angle relative to the top wall; and progressively and sequentially cutting the one or more pills with the angled blade. In another aspect the moving includes moving the at least one rail laterally across the top wall and at right angles to a longitudinal axis of the pill cutter device. The method further includes aligning the one or more pills along the longitudinal axis prior to bringing the blade into contact with the one or more pills. The moving of the at least one rail includes providing a first rail and a second rail and moving the first rail and the second rail across the top wall toward each other; and the immobilizing includes capturing the one or more pills between resilient pads provided on each of the first rail and the second rail. In some examples, the method further comprises sweeping the smaller pill segments off the top wall of the lower housing and into a container that is flush with or below a height of the top wall and then disengaging the container from the lower housing.

In other examples, the method includes moving a rail lock assembly to an unlocked position prior to moving the at least one rail laterally across the top wall. The method further includes moving the rail lock assembly to a locked position after moving the at least one rail laterally across the top wall. The moving of the rail lock assembly between the locked position and the unlocked position includes pivoting a rail lock extending from the lower housing in one of a first direction and a second direction. In one example, the moving of the at least one rail laterally across the top wall includes rotating a cam engaged with the at least one rail. The method further includes moving a rail lock assembly to an unlocked position prior to moving the at least one rail laterally across the top wall and moving the rail lock assembly to a locked position after moving the at least one rail laterally across the top wall. The moving of the rail lock assembly into the locked position includes preventing rotation of the cam.

In one example, the method includes moving the one or more pills longitudinally along the top wall with at least one pill holder prior to cutting the one or more pills with the blade. The method further comprises sliding the at least one pill holder longitudinally along the at least one rail in one of a first direction and a second direction. The method further includes engaging at least one tooth on the at least one pill holder with at least one tooth on the at least one rail. In some embodiments, the method includes limiting a lateral motion of the at least one rail on the top wall. The limiting includes extending at least one post extending downwardly from the at least one rail through a laterally-oriented slot provided on the top wall. The method further aligning the one or more pills along the longitudinal axis of the top wall with the at least one rail and above a slit defined in the top wall; where the slit is oriented along the longitudinal axis and passing at least a portion of the cutter blade into the longitudinally oriented slit during cutting of the one or more pills.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top, front perspective view of a pill cutter device in accordance with an aspect of the present disclosure, shown in a closed position;

FIG. 2 is a top, rear perspective view of the pill cutter device of FIG. 1;

FIG. 3A is an enlarged exploded top front perspective view of the upper housing of the pill cutter device;

FIG. 3B is an enlarged exploded top front perspective view of a first part of the lower housing of the pill cutter device; and

FIG. 3C is an enlarged exploded top front perspective view of a second part of the lower housing of the pill cutter device;

FIG. 4 is a side elevation view of the pill cutter device of FIG. 1;

FIG. 5 is a top, front perspective view of the pill cutter device shown in an open position;

FIG. 6 is a side elevation view of the pill cutter device of FIG. 5;

FIG. 7 is a front elevation view of the pill cutter device in the open position;

FIG. 8A is a top plan view of the pill cutter device taken along line 8A-8A of FIG. 6 with the upper housing removed, and showing the first and second rails and the pill holders in a first position and retaining a first plurality of tablets of a first shape and size;

FIG. 8B is a top plan view of the pill cutter device similar to FIG. 8A but showing the first and second rails and the pill cutters in a second position and retaining a second plurality of pills of a second shape and size;

FIG. 9A is a bottom plan view of the lower housing of the pill cutter device with the bottom pad and bottom cover removed and showing the pill cutter device in the first position;

FIG. 9B is a bottom plan view of the lower housing of the pill cutter device with the bottom pad and bottom cover removed and showing the pill cutter device in the second position;

FIG. 10 is a bottom rear perspective view of the pill cutter device with the bottom pad and bottom cover removed and showing the pill cutter device in the open position;

FIG. 11 is a longitudinal cross-section of the open pill cutter device with the pill holders in the first position and showing the rail lock in an engaged position;

FIG. 12 is a longitudinal cross-section of the open pill cutter showing the rail lock in a disengaged position and showing the pill holders moved to the second position;

FIG. 13 is a side elevation view showing the upper housing of the pill cutter device being pushed downwardly into a closed, cutting position;

FIG. 14 is a longitudinal cross-section of the pill cutter device shown in FIG. 13;

FIG. 15 is a side elevation view of the pill cutter device in the open position and showing the brush end of the brush tool being utilized to move cut pills downwardly toward the cut pill container;

FIG. 16 is a top front perspective view of the pill cutter device in the open position and showing the paddle end of the brush tool being used to slide the pill holders along the first and second rails, and showing the cut pill container lifted outwardly from the base.

Similar numbers refer to similar parts throughout the drawings.

### DETAILED DESCRIPTION

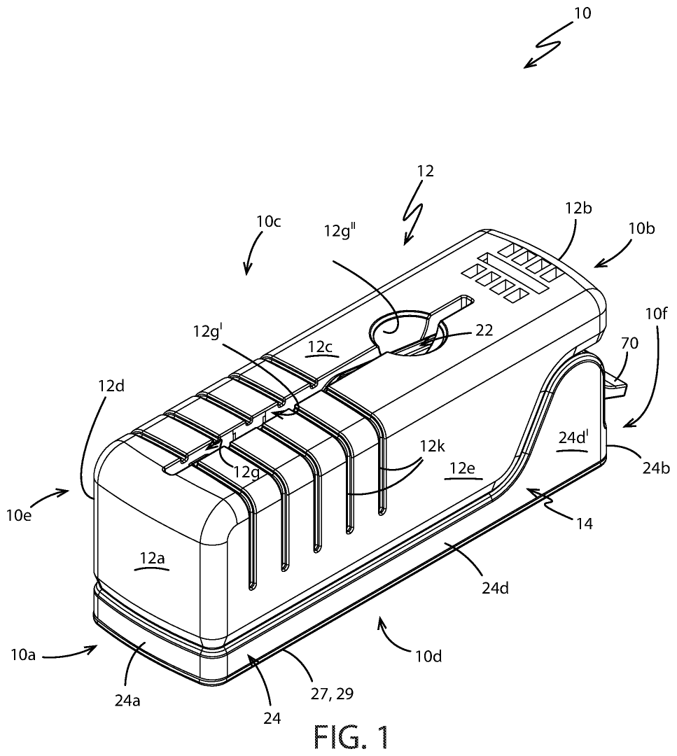

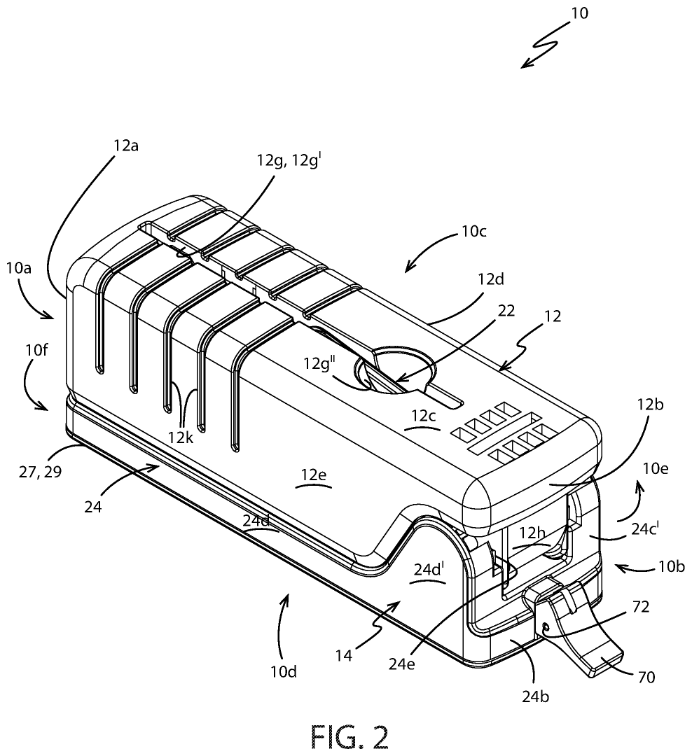

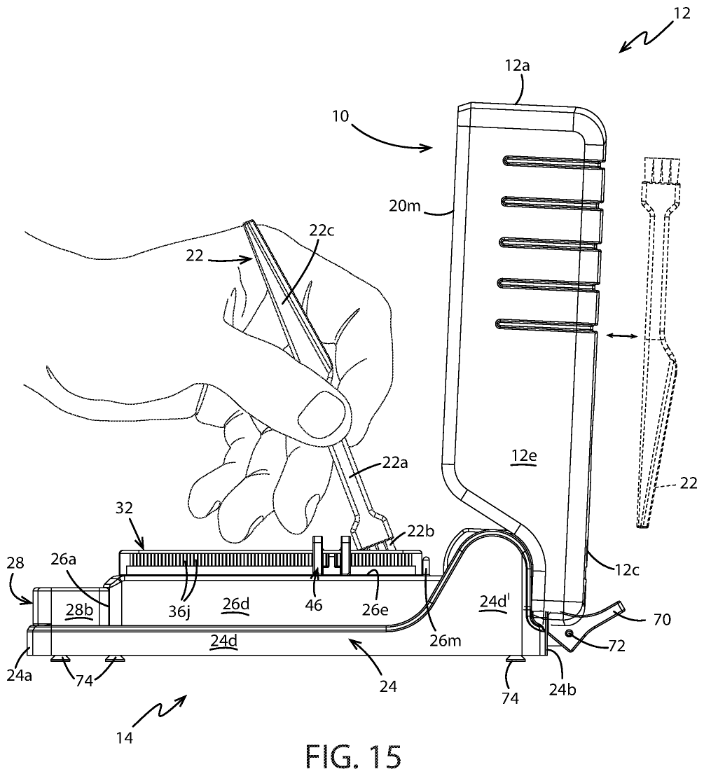

Referring to FIGS. 1-16, there is shown a pill cutter device in accordance with the present disclosure, generally indicated at 10. Pill cutter device 10 will be referred to hereafter by the term “device 10”.

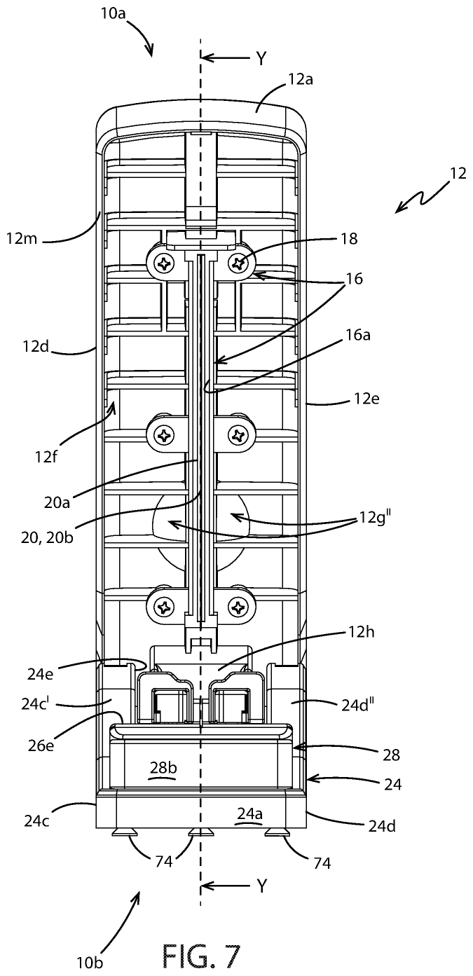

FIGS. 1, 2, and 4 show that device 10 generally has a front end 10a, a rear end 10b, a top 10c, a bottom 10d, a left side 10e, and a right side 10f. Front end 10a and rear end 10b device a longitudinal direction therebetween. A longitudinal axis “Y” (FIG. 7) extends between front end 10a and ear end 10b. Top 10c and bottom 10d define a vertical direction therebetween. Left side 10e and right side 10f define a lateral or transverse direction therebetween.

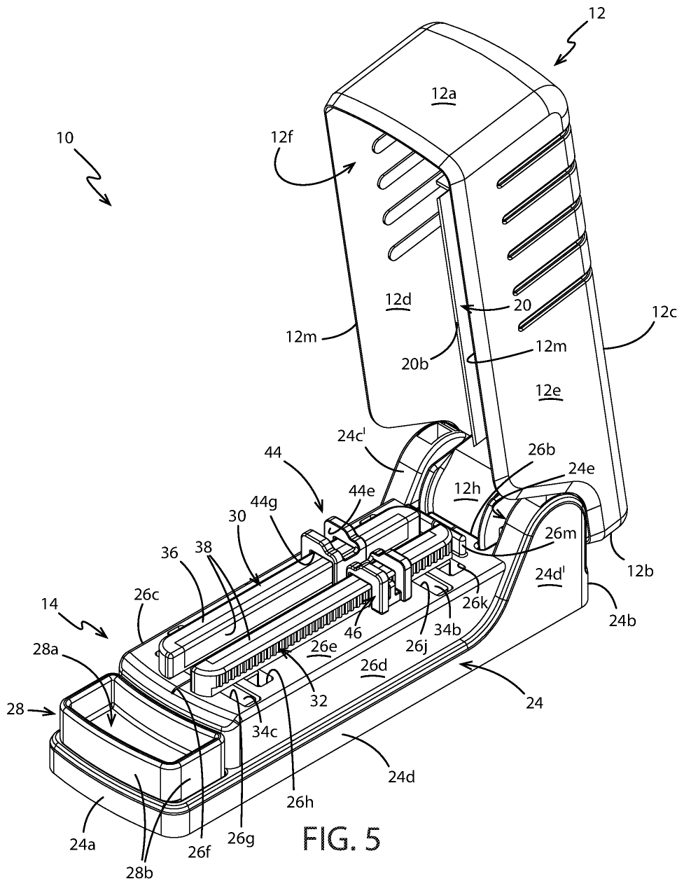

Device 10 comprises a lower housing 14 and an upper housing 12 that are pivotally engaged with each other in such a way that the upper housing 12 is able to pivot relative to lower housing 14 between a closed position (FIG. 1) and an open position (FIG. 5), as will be further described herein. When device 10 is in the open position, pills may be loaded into device 10 for cutting or cut pills may be removed from device 10. As will be described later herein, when device 10 is moved from the open position to the closed position, the motion results in any pills retained in the device 10 being cut.

Referring now to FIGS. 1-3A and 5, upper housing 12 has a front end 12a, a rear end 12b, a top wall 12c, a left side wall 12d, and a right side wall 12e. Front end 12a, rear end 12b, top wall 12c, left side wall 12d, and right side wall 12e bound and define an interior cavity 12f (FIG. 5). Top wall 12c of upper housing 12 defines a recessed region 12g therein. Recessed region 12g comprises a longitudinally oriented slot 12g′ and a substantially hemispherical depression 12g″. At least a portion of slot 12g′ extends through a region of hemispherical depression 12g″. In particular, the portion of slot 12g′ extends through a central region of hemispherical depression 12g″. A first section of slot 12g′ extends forwardly from depression 12g″ and a second section of slot 12g′ extends rearwardly from depression 12g″.

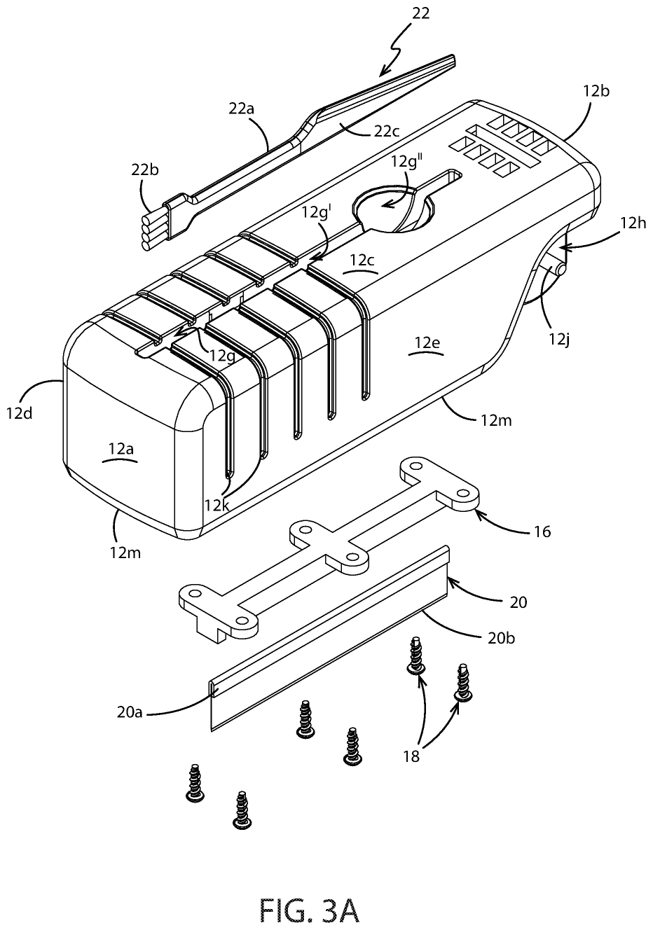

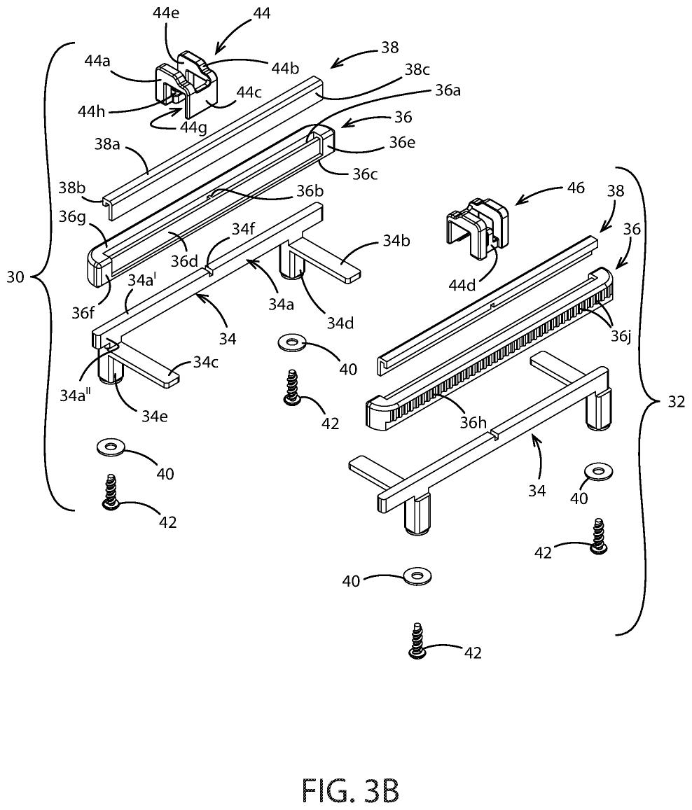

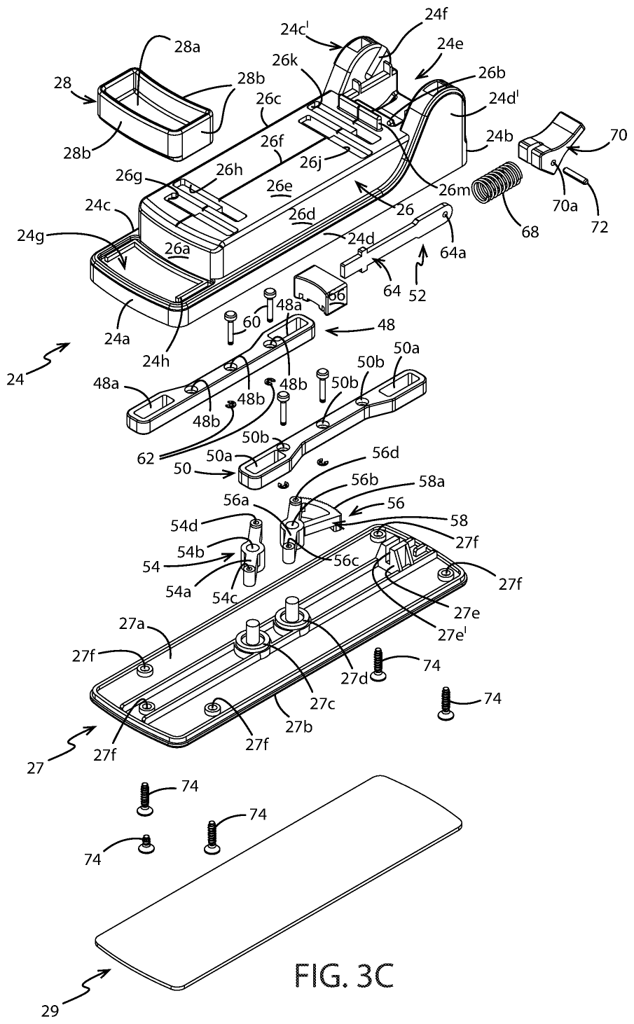

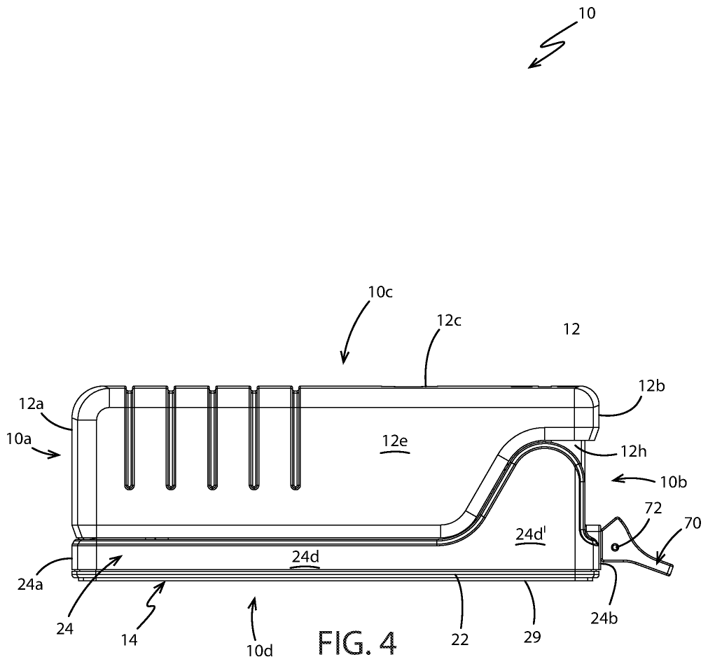

A projection 12h (FIG. 4) that extends downwardly from a portion of the interior surface of top wall 12c proximate rear wall 12b. Projection 12h is narrower in width that the distance between left side wall 12d and right side wall 12e. Projection 12h is shaped and sized to be engaged with lower housing 14, as will be described later herein. A pivot pin 12j (FIGS. 3A, 8A and 11) extends outwardly from each side of projection 12h. Pivot pins 12j are laterally aligned with each other and are oriented at right angles to longitudinal axis “Y”. Pivot pins 12j are provided to pivotally engage upper housing 12 to lower housing 14 and allow upper housing 12 to pivot relative to lower housing 14 between the open and closed positions.

Upper housing 12 may be provided with other features that are not described herein as they are not particularly relating to the manner in which pill cutter device 10 is utilized to cut one or more pills. For example, some type of texturing may be applied to the upper housing 12 to make the same easier to grip. The texturing may take any desired form including the provision of a plurality of grooves 12k therein. It will be understood that upper housing 12 may be shaped in any desired manner to be both aesthetically pleasing and ergonomically in design.

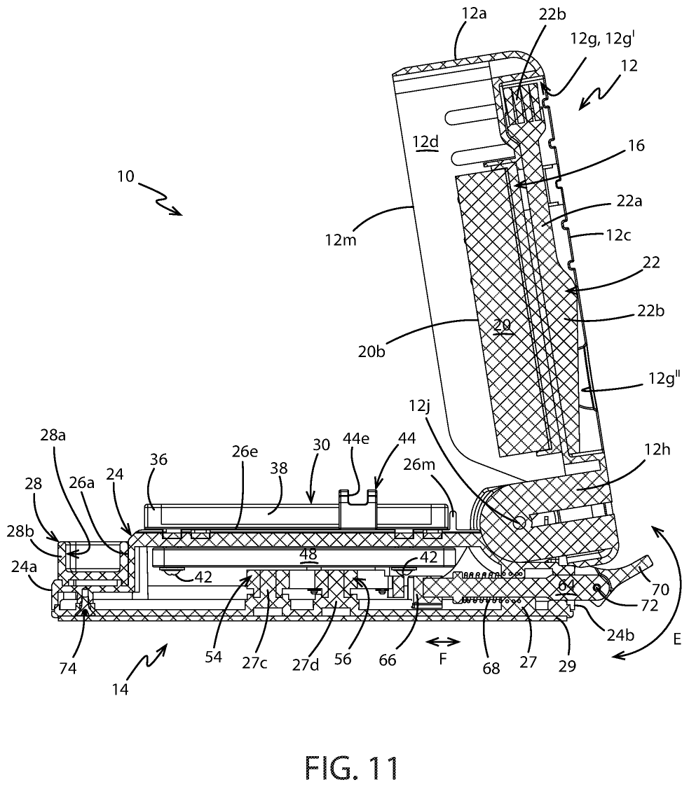

Referring to FIGS. 3A and 7, a blade bracket 16 is provided and is secured to the interior surface of top wall 12c by any suitable means, such as fasteners 18. In particular, blade bracket 16 is secured to the interior surface of top wall 12c aligned with recessed region 12g. FIG. 7 shows that blade bracket 16 defines a slot 16a therein that runs substantially the entire length of blade bracket 16. When blade bracket 16 is engaged with top wall 12c, slot 16a extends along the longitudinal axis “Y”. A blade 20 (FIG. 3A) is provided for engagement in slot 16a of blade bracket 16. Blade 20 has a base 20a that is received in slot 16a of blade bracket 16 and is secured therein by any suitable means. For example, base 20a may be secured by a friction fit in slot 16a. In another example, an adhesive may be utilized to secure base 20a in slot 16a. In yet another example, fasteners may be utilized to secure base 20a to blade bracket 16 when base 20a is received in slot 16a. Blade 20 includes a cutting edge 20b that forms the lowermost edge of blade 20 when blade 20 is engaged in blade bracket 16. As best seen in FIG. 11, when blade 20 is engaged in blade bracket 16, the cutting edge 20b is located a distance inwardly from a bottom edge 12m of upper housing 12. Blade 20 is therefore recessed within interior cavity 12f of upper housing 12. As a result, a user is unlikely to accidentally come into contact with cutting edge 20b and cut themselves.

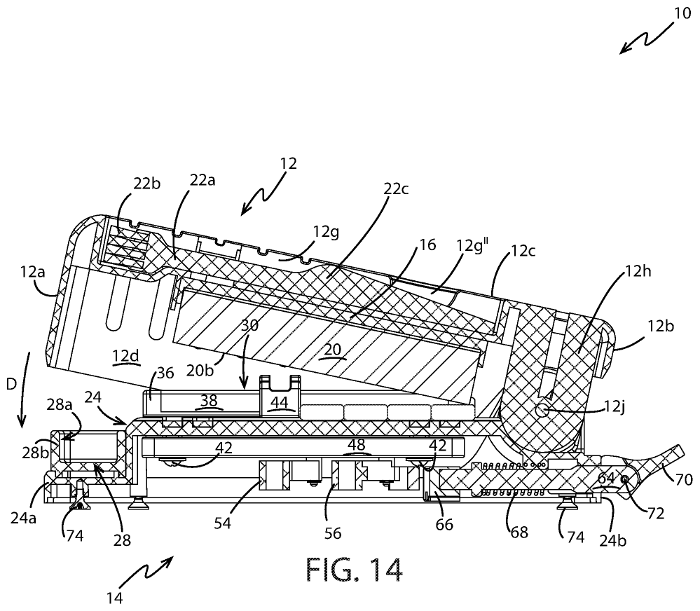

While blade 20 is arranged at right angles to the interior surface of top wall 12c, upper housing 12 is pivotally engaged with lower housing 14. Consequently, when upper housing 12 is pivoted downwardly toward pills retained in lower housing (as will be described later herein), the cutting edge 20b of blade 20 will progressively contact the pills to be cut at an angle relative to an upper surface of the pills. FIG. 14 shows clearly that the blade 20 is oriented at an angle other than ninety degrees relative to the top wall of lower housing 14. Consequently the rear end of the blade 20, i.e., the end proximate projection 12h in FIG. 14 will contact the rearmost pill to be cut first and the last pill to be cut will be the forwardmost pill proximate the pill holders 44, 46.

A brush tool 22 (FIG. 3A) is removably received within recessed region 12g defined in upper housing 12. Brush tool 22 includes a shaft 22a having a plurality of bristles 22b at a first end. A portion of the shaft 22b from approximately midway along the length of shaft 22a to a second end thereof is flattened and shaped into a generally triangular region. The second end of the shaft 22a forms the apex of the triangular region. This flattened, triangular region forms a paddle 22c. The purpose of bristles 22b and paddle 22c will be described later herein. Brush tool 22 is placed in recessed region 12g of upper housing 12 for storage purposes. The thickness of paddle 22 (i.e., from a front surface thereof to a rear surface thereof) relative to recessed region 12g is such that brush tool 22 is retained in recessed region 12g by friction. So, when upper housing 12 is pivoted between the open position and closed position, brush tool 22 will remain in recessed region 12g. When brush tool 22 is placed in recessed region 12g, a portion of paddle 22c will extend through semi-hemispherical depression 12g″. The curvature of depression 12g″ makes it possible for a user to insert the tip of their thumb and index finger into the depression 12g″ and grasp and lift brush tool 22 out of recessed region 12g. The curvature of depression 12g″ also helps the user to position paddle 22c and thereby brush tool 22 back into recessed region 12g.

Referring mainly to FIG. 3C, lower housing 14 includes a base 24, a bottom cover 27, and a bottom pad 29. Bottom cover 27 is placed over a lowermost end of base 24 and bottom pad 29 is engaged below bottom cover 27. Base 24 has a front end 24a, a rear end 24b, a left side 24c, and a right side 24d. Left side 24c and right side 24d are substantially identical in shape and size but are arranged as mirror images of each other on base 24. Each of the left side 24c and right side 24d includes an enlarged lobe 24c′, 24d′ proximate rear end 24b. A gap 24e is defined between an interior surface of lobe 24c′, a portion of an upper surface (not numbered) of base 24, and an interior surface of lobe 24d′. The gap 24e is sized and shaped to receive projection 12h of upper housing 12 therein. As is evident from FIG. 3C, an angled slot 24f is defined in the interior surface of lobe 24c. An identical angled slot is defined in the interior surface of lobe 24d′. The two angled slots 24f are aligned laterally with each other and are provided to receive the pivot pins 12j that extend outwardly from the projection 12h on upper housing 12.

Referring to FIG. 3C, the base 24 includes a top surface that defines a depression 24g proximate front end 24a. Depression 24g is bounded on the top surface by a U-shaped wall 24h and upstanding portions of front end 24, left side 24c, and right side 24d. The top surface of base 24 includes a raised region 26 that originates rearwardly of wall 24h and extends longitudinally to a location between the interior surfaces of lobe 24c′ and lobe 24d′. Raised region 26 has a front end 26a, a rear end 26b, a left side 26c, a right side 26d, and a top wall 26e. Top wall 26e extends from front end 26a to rear end 26b, and from left side 26c to right side 26d. Top wall 26e is substantially flat except for a number of interrupted regions. Firstly, a longitudinally-oriented slot 26f is defined in top wall 26e. Slot 26f originates a short distance rearwardly of front end 26a and terminates a short distance forwardly from rear end 26b. Slot 26f is aligned with the longitudinal axis “Y” of device 10. Slot 26f is vertically aligned with blade 20 in upper housing 12 to a sufficient degree that when upper housing 12 is moved to the closed position, the cutting edge 20b and a portion of blade 20 travel into slot 26f. Because upper housing 12 is pivotally engaged with lower housing 14, blade 20 will be oriented at an angle of greater than ninety degrees relative to the upper surface of top wall 12c when pill cutter device 10 is in the open position (FIG. 5). As the front end of upper housing 12 is pushed downwardly toward the front end of lower housing 14 when pill cutter device 10 is being moved from the open position to the closed position, the rearmost end of the blade 20 will enter the rear end of the slot 26f first. As the downward pivotal motion is continued, the rest of blade 20 will gradually and progressively enter slot 26f.

FIG. 3C also shows that top wall defines four laterally-oriented grooves 26g, 26h, 26j, 26k. Each of the slots 26g and 26j originate proximate right side 26d and extend toward left side 26c, terminating a distance inwardly from left side 26c. Each of the slots 26h and 26k originate proximate left side 26c and extend toward right side 26d, terminating a distance inwardly from right side 26d. Slot 26g and slot 26j are aligned longitudinally with each other. Slot 26h and slot 26k are aligned longitudinally with each other and are longitudinally offset relative to slots 26g and 26j. The slots 26g, 26h, 26j, 26k are not of a uniform width along their entire length but instead include a first region of a first width and a second region of a second width that is narrower than the first width. Each slot 26g, 26h, 26j, 26k extends from an upper surface of top wall 26e through to a lower surface thereof.

FIG. 3C further shows that a retaining wall 26m extends vertically upwardly for a distance from top wall 26e. Retaining wall 26m is located a short distance forwardly of rear end 26b and is oriented laterally. In particular, retaining wall 26m is oriented at right angles to longitudinal axis “Y”. Retaining wall 26m is bisected by slot 26f. In other words, a portion of blade 20 will travel through a gap defined in retaining wall 26m when upper housing 12 is moved to the closed position. It should be noted that the entire length of the cutting edge 20b of blade 20 does not simultaneously enter slot 26f. Instead, the rearmost end of cutting edge 20b (i.e. the region closest to rear end 12b of upper housing 12, enters slot 26f first in a region just forward of retaining wall 26m. The cutting edge 20b then progressively is lowered into slot 26f from proximate the rear end to proximate the front end thereof. The front end of the slot 26f is proximate container 28.

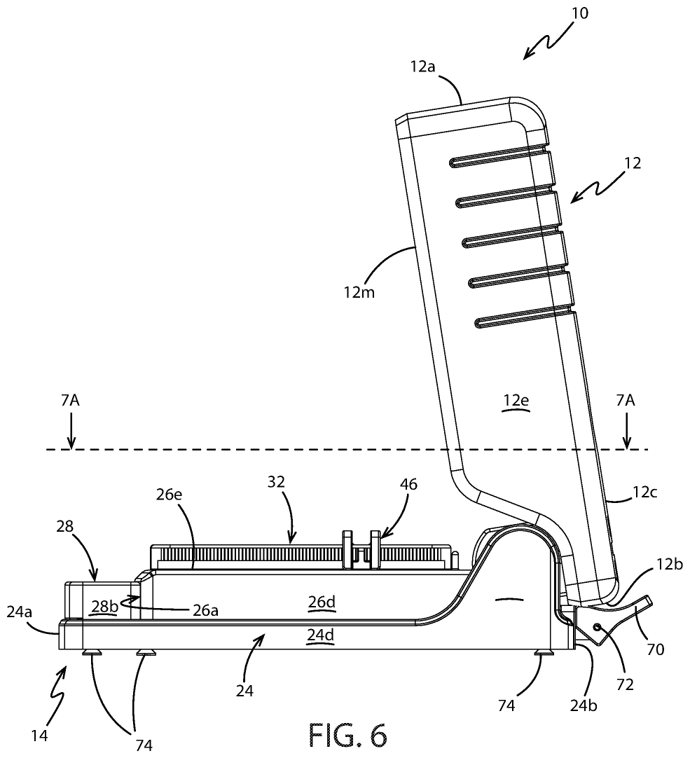

Still referring to FIG. 3C, a removable cut-pill container 28 is insertable into and removable from depression 24g that is defined in base 24. Container 28 defines a chamber 28a therein that is bounded and defined by a bottom wall (not numbered) and a peripheral side wall 28c. Peripheral side wall 28c extends upwardly from the bottom wall. The peripheral side wall 28b of container 28 is of a vertical height that is one of slightly lower than the height of top wall 26e of region 26 or flush with the top wall 26e. This can be best seen in FIG. 6. The difference in height or the fact that the height of the side wall 28b and top wall 26e is the same makes it possible to slide cut pills off top wall 26e and into chamber 28a. This will be described later herein.

Lower housing 14 includes a first plurality of components located above an upper surface of top wall 26e of base 24 and a second plurality of components located below a lower surface of top wall 26e of base 24. The first plurality of components are illustrated in FIG. 3B and the second plurality of components are illustrated in FIG. 3C.

Referring to FIGS. 3B and 5, the first plurality of components includes a first ratchet rail 30 and a second ratchet rail 32. First and second rails 30, 32 are substantially identical in structure and function but are engage in lower housing 14 as mirror images of each other. Because first and second rails 30, 32 are substantially identical, only the structure of first ratchet rail 30 will be described in detail.

First ratchet rail 30 comprises a rail sliding rack 34, a ratchet rail 36, and a rail pad 38. Each of the rail sliding rack 34, the ratchet rail 36 and rail pad 38 have a unique and specific function. Rail sliding rack 34 comprises a support bar 34a with a first arm 34b and a second arm extending outwardly from one side of support bar 34a. The first arm 34b is located a short distance inwardly from a first end of support bar 34a and the second arm 34c is located a short distance inwardly from a second end of support bar 34a. First and second arms 34b, 34c extend outwardly from a lower region of support bar 34a. In other words, a portion of support bar 34a extends upwardly beyond an upper surface of each of the first arm 34b and second arm 34c. First ratchet rail 30 further comprises a first post 34d and a second post 34e that extend downwardly from a lower surface of support bar 34a. The first post 34d is aligned with first arm 34b and second post 34e is aligned with second arm 34c.

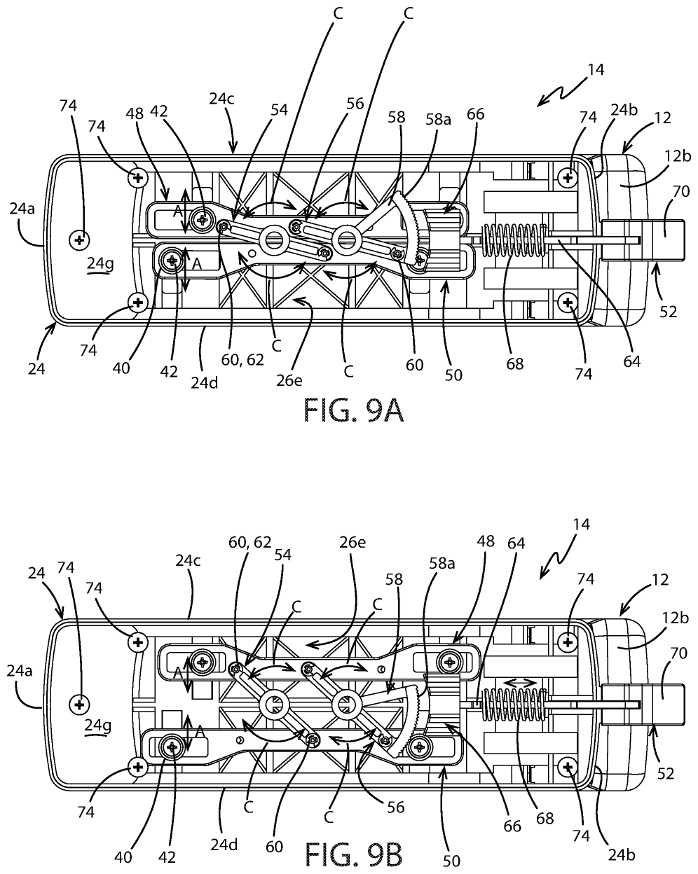

The longitudinal spacing between first arm 34b and second arm 34c is the same as the spacing between slot 26g and slot 26j in base 24. First arm 34b is of a width suitable to be received in slot 26g and second arm 34c is of a width suitable to be received in slot 26j. Each of the first arm 34b and second arm 34c is of a shorter length than the associated slot 26g, 26j. This arrangement makes it possible for first ratchet rail 30 to slide laterally back and forth within slots 26g, 26j. As indicated earlier herein, a portion of each of the slots 26g, 26h, 26j, 26k is of a greater width than the rest of the associated slot 26g, 26h, 26j, 26k. The posts 36d, 36e are received in these greater width areas and the first and second arms 34b, 34c slide above the narrower width area of the slots 26, 26j. Posts 36d, 36e are inserted through the associated slots 26j, 26g defined in top wall 26e of base 24. As shown in FIGS. 3B and 9A, a washer 40 and fastener 42 are ultimately utilized to secure each post 36d, 36e into engagement components located below the lower surface of top wall 26e, as will be discussed hereafter. The interaction between the rail sliding racks 34 of first and second ratchet rails 30, 32 and the slots 26g, 26h, 26j, 26k of base 24 allows the rails 30, 32 to move smoothly in a defined minimum and maximum position along a transverse axis of the lower housing 14.

Referring to FIG. 3B, support bar 34a of first ratchet rail 30 defines at least one notch 34f in an upper surface thereof. Support bar 34a also is of a thickness measured between a first side 34a′ and a second side 34a″ thereof. As illustrated a single notch 34f is defined in the upper surface of support bar 34a generally midway between a first end and a second end thereof.

Ratchet rail 36 (FIG. 3B) has a body that defines a vertical slot 36a therein. Slot 36a is of a length and a width that is suitable to receive support bar 34a of rail sliding rack 34 therein. A vertically oriented ridge 36b extends inwardly into slot 36a from one of the interior walls that define slot 36a. Ridge 36b is located and configured to be complementary to notch 34f defined in support bar 34a. Ratchet rail 36 is positioned vertically above support bar 34a and is lowered downwardly over support bar 34a (with bar 34a moving into slot 36a) and until a bottom region 36c of rail 36 contacts the upper surfaces of first arm 34b and second arm 34c. An interior side wall 36d of rail 36 is recessed a distance inwardly from side regions 36e, 36f. A top surface of side wall 36d is also recessed a distance downwardly from top wall 36g. As best seen with respect to rail 32, an exterior side wall 36h is provided with a plurality of teeth 36j. As illustrated in FIG. 3b, Teeth 36j are vertically oriented are spaced apart at intervals from each other.

Pad 38 is an inverted substantially J-shaped member when viewed from the front end. The J-shaped pad 38 is configured to fit into the recessed regions of rail 36 such that a first leg 38a of pad 38 extends over the top surface of the side wall 36d and a second leg 38b of pad 38 extends downwardly into slot 36a and rests on the upper surface of support bar 34a. A third leg 38c of pad 38 extends downwardly in front of support bar 34a. The exterior surface of third leg 38c is substantially flush with an exterior surface of each of the side regions 36e, 36f. Pad 38 is comprised of a resilient, high friction material. One suitable material for pad 38 is silicone.

The first plurality of components located above the upper surface of top wall 26e of base 24 further includes a first pill holder 44 and a second pill holder 46. First pill holder 44 is provided to engage first ratchet rail 30 and second pill holder is provided to engaged second ratchet rail 32. First pill holder 44 and second pill holder 46 are substantially identical to each other but are arranged in pill cutting device a mirrored orientation relative to each other. Because first and second pill holders 44, 46 are substantially identical in structure and function, only first pill holder 44 will be described herein. First pill holder 44 includes a front wall 44a and a rear wall 44b that are connected by side walls 44c, 44d (see second pill holder 46). Front wall 44a and rear wall 44b are spaced longitudinally from each other, being separated by a space 44e. Each of the front wall 44a and rear wall 44b are substantially an inverted U-shaped and together define a longitudinally extending channel 44g. Channel 44g is complementary in size to with width of first ratchet rail 30 and first pill holder 44 fits over a top end of first ratchet rail 30. (Second pill holder 46 fits over a top end of second ratchet rail 32.) One or more teeth 44h extend inwardly from side wall 44d and into channel 44g. The one or more teeth 44h are shaped and sized to interlockingly engage with teeth 36j of first ratchet rail 30. The interlocking engagement of teeth 44h on pill holder 44 and teeth 36j on first ratchet rail 30 (specifically on ratchet rail 36) cause the adjustable first pill holder 44 to have resistance when pushed or pulled along first ratchet rail 30. First pill holder 44 is able to be selectively moved along the length of first rail in either of a first direction or a second direction. Because of the interlocking engagement of teeth 44h and 36j and the resulting resistance to movement of the pill holder 44, a user cannot accidentally slide pill holder 44 along first ratchet rail 30. Accidental sliding motion of pill holder 44 (and pill holder 46) would permit pills or tablets retained within pill cutter device to possible move when blade 20 is brought into contact therewith. Accidental movement of pill holders 44, 46 might, in turn, result in blade 20 not being able to make a clean cut through the pills or tablets, or could lead to crushing some of the compressed material in the pills or tablets, or could result in cutting of the pills or tablets at a location other than their centerline, thereby producing differently sized pill or tablet pieces. The tendency to crush pills or tablets with blade 20 is reduced because blade 20 contacts the pills or tablets at an angle instead of being brought straight downwardly at right angles to top wall 26c.

FIG. 3C shows the second plurality of components that form part of lower housing 14 that are located under the lower surface of top wall 26e of base 24. The second plurality of components includes a first rail 48, a second rail 50, a rail lock assembly 52, and some type of linkage that engages the first rail and second rail 48, 50. The linkage as illustrated comprises a first cam 54, and a second cam 56. Each of the first cam 54 and second cam 56 are rotating cams. Second cam 56 differs from first cam 54 in that it includes a stop 58 having a plurality of teeth 58 on an outermost surface thereof.

First rail 48 and second rail 50 are substantially identical in structure and function. First rail 48 is an elongate member that has an upper surface and a lower surface. A pair of slots 48a is defined in first rail 48 with each slot 48a extending from the upper surface through to the lower surface. One of the slots 48a is located proximate a first end of first rail 48 and the other of the slots 48a is located proximate a second end of first rail 48. A plurality of holes 48b is defined at spaced-apart intervals between the slots 48a. Each hole 48b extends from the upper surface through the lower surface of the first rail 48. Preferably, first rail 48 defines three holes 48b therein. Second rail 50 is an elongate member that has an upper surface and a lower surface. A pair of slots 50a is defined in second rail 50 with each slot 50a extending from the upper surface through to the lower surface. One of the slots 50a is located proximate a first end of second rail 50 and the other of the slots 50a is located proximate a second end of second rail 50. A plurality of holes 50b is defined at spaced-apart intervals between the slots 50a. Each hole 50b extends from the upper surface through the lower surface of the second rail 50. Preferably, second rail 50 defines three holes 50b therein.

First cam 54 includes an arm 54a having a central hub with a central opening 54b defined therein. Arm 54a defines end openings 54c, 54d proximate opposite ends of the arm. All of the openings 54b, 54c, and 54d extend from an upper surface to a lower surface of first cam 54. Similarly, second cam 56 has an arm with a central hub that defines a central opening 56b therein. End openings 56c, 56d are defined proximate opposite ends of the arm of second cam 56. Each of the openings 56b, 56c, and 56d extend from an upper surface through to a lower surface of the arm. Stop 58 is concentrically oriented relative to the central hub of second cam 56.

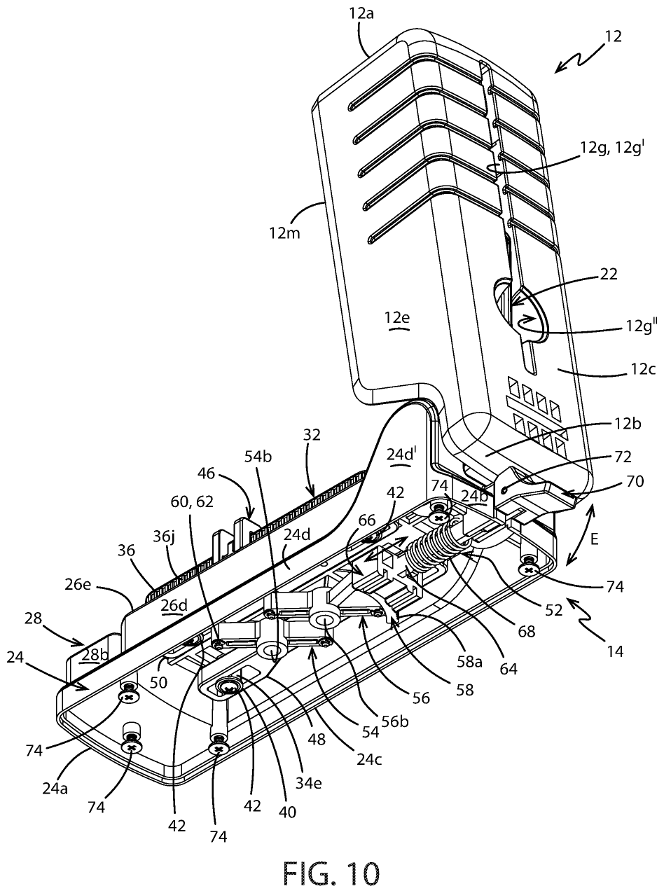

First cam 54 and second cam 56 are engaged with first rail 48 and second rail 50 as can best be seen in FIGS. 9A and 9B. Fasteners 60 (FIG. 3C) and lock washers 62 are utilized to secure first cam 54 and second cam 56 to first rail 48 and second rail 50. Holes 48b in first rail 48 are aligned with holes 54d, 56d in cams 54, 56 and fasteners 60 are inserted therethrough. Similarly, holes 50b in second rail 50 are aligned with holes 54c, 56c in cams 54, 56 and fasteners 60 are inserted therethrough. Lock washers 62 secure the fasteners 60 in place. Additionally, fasteners 42 (FIG. 3B and 10) are inserted through slots 48a of first rail 48 (or through slots 50a of second rail 50) and into threaded bores defined in the posts 34d, 34e of first ratchet rail 30 and second ratchet rail 32. Fasteners 42 therefore secure first rail 48 to first ratchet rail 30 and secure second rail 50 to second ratchet rail 32. It should be noted that when first ratchet rail 30 and first rail 48 are secured to each other and second ratchet rail 30 and second rail 50 are secured to each other, slots 48a, 50a are oriented substantially parallel to longitudinal axis “Y” and at right angles to slots 26g, 26h, 26j, 26k. Posts 34d, 34e on first ratchet rail 30 and second ratchet rail 32 are therefore able to be selectively moved longitudinally along slots 48a, 50a and/or laterally along the associated slots 26g, 26h, 26j, 26k.

Rail lock assembly 52 comprises a latch plate 64 that is oriented longitudinally within lower housing 14. A rubber stop 66 is engaged with a forwardmost end of latch plate 64. Rubber stop 66 is positioned beneath top wall 26e in such a way that stop 66 may operatively be moved into contact with stop 58 on second cam 56 or out of contact with stop 58. A coil spring 68 is wrapped around a portion of latch plate 64 forwardly of rubber stop 66. A rail lock 70 is pivotally engaged with a rear end of latch plate 64 via a pin 72. (Pin 72 is passed through aligned holes 70a, 64a (FIG. 3C) in rail lock 70 and latch plate 64.) Rail lock 70 is able to be pivoted upwardly or downwardly relative to rear end 24b of base 24 as will be described later herein.

Referring again to FIG. 3C, bottom cover 27 is a substantially planar member having an upper surface 27a and an opposed lower surface 27b. A first mounting 27c and a second mounting 27d extend upwardly from upper surface 18a. Each of the first mounting 27c and second mounting 27d includes an upstanding post that is engageable with the central hole 54b of first cam 54 and the central hole 56b of second cam 56 respectively. First cam 54 is able to rotate about the post that extends upwardly from first mounting 27c and second cam 56 is able to rotate about the post that extends upwardly from second mounting 27d. The rotation is indicated by the arrows “C” in FIGS. 9A and 9B. A mounting bracket 27e extends upwardly from upper surface 18a of bottom cover 27, a longitudinal distance rearwardly away from second mounting 27d and proximate a rear end of bottom cover 27. A section of latch plate 64 is received in a slot 27e′ defined in mounting bracket 27e. Mounting bracket 27e is positioned such that spring 68 is located between mounting bracket 27e and second mounting 27d, and rail lock 70 is located exteriorly of mounting bracket 27e and extends outwardly beyond the rear end of bottom cover 27 and thereby beyond the rear end 24b of base 24.

Bottom cover 27 also defines a plurality of through holes 27f therein. Fasteners 74 are inserted through the holes 27f in bottom cover 27 and into threaded recesses (not numbered) defined in a lower surface of base 24. Fasteners 74 therefore secure bottom cover 27 to base 24. Bottom pad 29 is engaged with cover 27 in any suitable manner including but not limited to snap fitting engagement of the two components, utilizing an adhesive, or utilizing fasteners, such as fasteners 74.

As is particularly shown in FIGS. 9A through 10, first cam 54 and second cam 56 operatively engage first rail and first ratchet rail 48,30 to second rail and second ratchet rail 50, 32. Consequently, if first and second cams 54, 56 rotate and thereby cause first rail 48 and second rail 50 to move toward each other, then first and second ratchet rails 30, 32 also move toward each other since first and second rails 48, 50 and first and second ratchet rails 30, 32 are operatively engaged and move in unison with each other. Similarly, if first and second cams 54, 56 rotate and thereby causes first rail 48 and second rail 50 to move laterally apart from each other, then first and second ratchet rails 30, 32 will also move laterally apart from each other.

Rail lock assembly 52 is movable between a locked position and an unlocked position. In a locked position, rail lock assembly 52 prevents rotation of second cam 56. If second cam 56 is prevented from rotating, then first cam 54 is also locked against rotation and the lateral position of first and second rails 48, 50 and consequently of first and second ratchet rails 30, 32 cannot be changed. Rail lock assembly 52 is in a locked position when rubber stop 66 is urged rearwardly into engagement with the semi-circular stop 58 provided on second cam 56. In particular, the teeth 58a on stop 58 bite into the rubber of rubber stop 66 and second cam 56 therefore cannot rotate either clockwise or counterclockwise. The rail lock assembly 52, when activated, acts on the rubber stop 66 with a substantially continuous force, and the rubber stop 66 in turn acts on the stop 58 with a substantially continuous force and this action stops second cam 56 from rotating. Rail lock assembly 52 is engaged when a user wishes to load tablets 80 or pills 82 into device 10. Rail lock assembly 52 is disengaged once the tablets 80 or pills 82 have been placed on top wall 26e as will be described hereafter and it is desired to adjust the positions of the first and second ratchet rails 30, 32 to lock the tablets 80 or pills 82 in place. Once the first and second ratchet rails 30, 32 are engaged with the tablets or pills, the rail lock assembly 52 is moved back to the locked position to ensure the tablets or pills are held immobile for the cutting procedure.

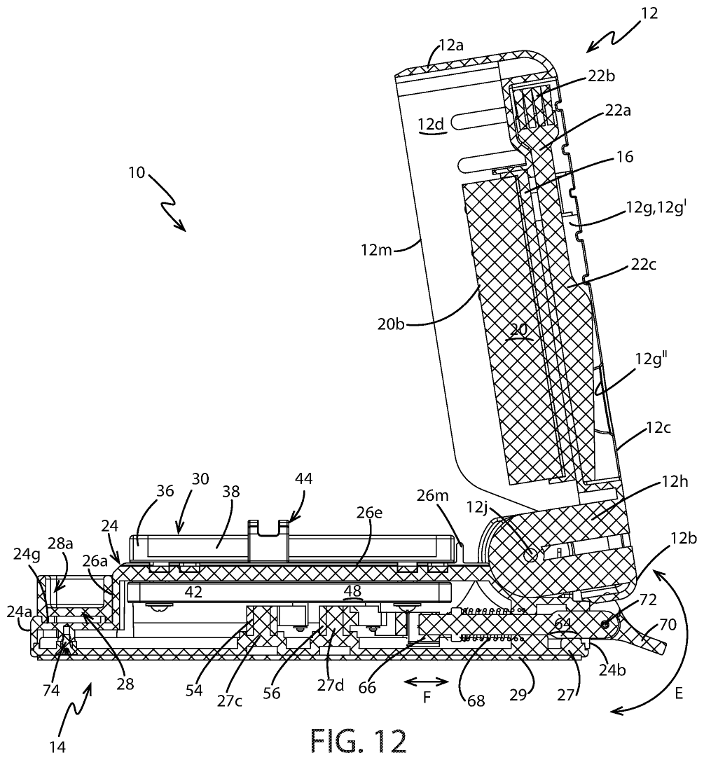

Rail lock assembly 52 is engaged and moved to the locked position by pivoting the rail lock 70 in a first direction. The rail lock assembly 52 is disengaged and moved to the unlocked position by pivoting the rail lock 70 in a second direction. Latch plate 64 is able to move longitudinally in the direction indicated by arrow “F” (FIGS. 11 and 12). For example, if rail lock 70 is pivoted upwardly away from the horizontal and toward the upper housing 12, latch plate 64 moves forwardly toward front wall 24a of base. This forward movement of latch plate 64 brings rubber stop 66 into contact with stop 58 and therefore rail lock assembly 52 is in the locked position and second cam 56 cannot rotate. (This is shown in FIG. 11). If rail lock 70 is pivoted downwardly away from the horizontal and away from the upper housing 12, latch plate 64 is moved rearwardly toward rear end 24b of lower housing 14. Rubber stop 66 moves rearwardly with latch plate 64 and therefor is moved out of engagement with stop 58. Rail lock assembly 52 is therefore in the unlocked position and second cam 56 is able to rotate. (Spring 68 is compressed when rail lock 70 is pivoted in this manner.) FIG. 12, for example, shows rail lock assembly 52 in the unlocked position.

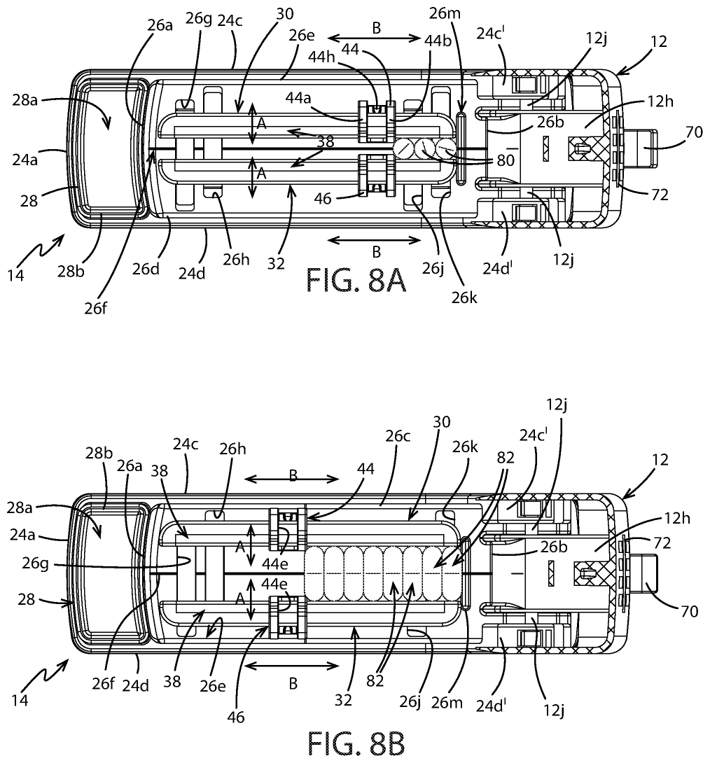

Pill cutter device 10 is utilized in the following way. The user will select the type of pill or tablet that is to be cut utilizing pill cutter device 10. FIGS. 8A and 8B show two differently shaped and sized pills and tablets to be cut. FIG. 8A shows three round tablets 80 secured in pill cutter device 10. FIG. 8B shows eight oblong pills 82 secured in pill cutter device 10. As is evident from FIGS. 8A and 8B, the size, shape, and number of tablets 80 that are to be cut using pill cutter device 10 is quite different from the size, shape, and number of pills 82 that are to be cut using pill cutter device 10. Consequently, prior to placing and cutting the tablets 80 or pills 82, device 10 has to be configured to receive the particular size, shape, and number of tablets or pills to be cut thereby. It will be understood that the two shapes and sizes of pill and tablet illustrated herein is exemplary only since the pill cutter device 10 is capable of receiving and cutting a wide range of different shaped and sized pills and tables therein.

Pill cutter device 10 is configured in the following manner. The user is able to move first ratchet rail 30 and second ratchet rail 32 laterally inwardly toward each other or laterally outwardly away from each other. (Rail lock assembly 52 may need to be moved to the unlocked position before first ratchet rail 30 and second ratchet rail 32 can be moved.) The lateral inward and outward movement of first and second ratchet rails 30, 32 is indicated by the arrows “A” in FIG. 8A. The first cam 54 and second cam 56 are operatively engaged with both of the first ratchet rail 30 and the second ratchet rail 32. Because each cam 54, 56 rotates about a central post (extending upwardly from mountings 26c, 26d, if the uses moves one of the ratchet rails 30, 32 laterally inwardly toward a longitudinal centerline of the base 24 (i.e., toward longitudinal axis “Y” or slit 26e), the other ratchet rail 30 or 32 will simultaneously also move laterally inwardly toward the longitudinal centerline or slit 26e. Conversely, if the user moves one of the ratchet rails 30 or 32 laterally outwardly away from the longitudinal centerline of the base 24, i.e., away from slit 26e, then the other ratchet rail 30 or 32 will simultaneously also move laterally outwardly away from the longitudinal centerline or slit 26e.

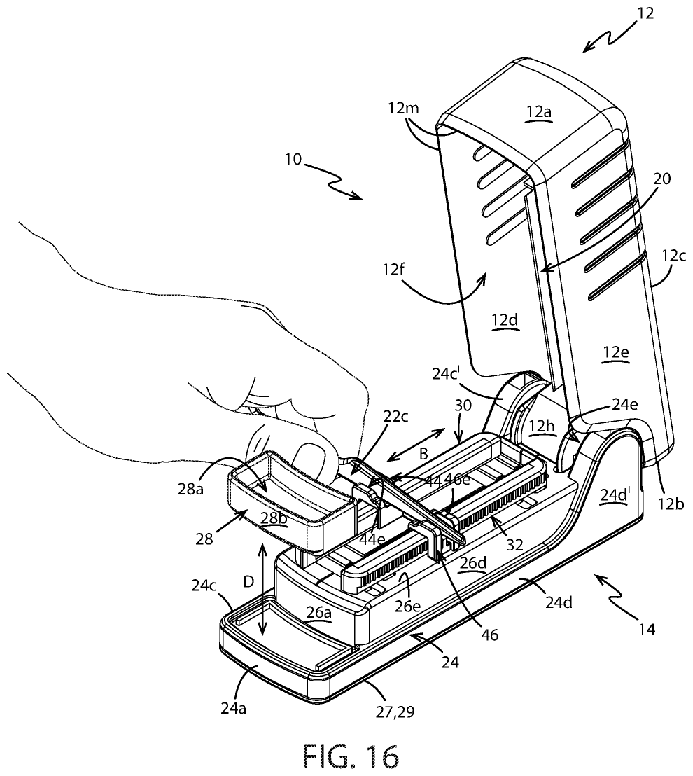

The user initially may move first and second ratchet rails 30, 32 laterally outwardly away from each other to enlarge a gap defined between the two pads 38. The user may slide pill holders 44, 46 longitudinally forwardly away from retaining wall 26m and toward container 28 or in the opposite direction along the associated one of the first and second ratchet rails 30, 32 and thereby parallel to the longitudinal axis “Y” of the device 10. Pill holders 44, 46 may be moved by engaging paddle 22c of brush tool 22 in the aligned slots 44e, 46e (FIG. 8B) of pill holders 44, 46 and pulling brush tool 22 in a direction toward container 28 and away from retaining wall 26m. In other instances, pill holders 44, 46 may be moved by applying force with a fingertip. The advantage of using brush tool 22 is that the pill holders 44, 46 may be moved in unison and to the same degree. FIG. 16 shows paddle 22c of brush tool 22 engaged in slots 44e, 46e. The user may move paddle 22c and thereby move pill holders 44, 46 in unison in either direction indicated by the arrow “B” (FIGS. 8A, 8B and 16). Once there is sufficient space between retaining wall 26m and pill holders 44, 46 and between first and second ratchet rails 30, 32, the user will place one or more tablets 80 or pills 82 on the flat upper surface 26e of region 26 in the space bounded and defined between first and second ratchet rails 30, 32, pill holders 44, 46 and retaining wall 26m. If more than one tablet 80 or pill 82 is to be cut, the tablets 80 or pills 82 will be arranged generally in a single row. The orientation of tablets 80 in the row will be irrelevant since they are round. Pills 82 on the other hand oblong in shape and are therefore oriented so that their lengths are at right angles to longitudinal axis “Y” of base 24.

The user will move the first and second ratchet rails 30, 32 laterally inwardly toward each other to a sufficient degree until the tablets 80 or pills 82 are very loosely retained between pads 38 thereon. The user will then push the row of tablets 80 or pills 82 rearwardly toward retaining wall 26m. This may be accomplished as shown in FIG. 16 by engaging the paddle 22c of brush tool 22 in the aligned slots 44e, 46e of pill holders 44, 46 and pushing the pill holders 44, 46 rearwardly toward retaining wall 26m until the rear walls 44b, 46b of pill holders 44, 46 contact the forwardmost tablet 80a or forwardmost pill 82a. Retaining wall 26m limits the longitudinal rearward movement of the tablets 80 or pills 82.

First and second ratchet rails 30, 32 may then be pushed an additional amount laterally inwardly toward each other until the row of tablets 80 or the row of pills 82 is sufficiently gripped between the silicone pads 38 of the first and second ratchet rails 30, 32 that the pills or tablets are substantially immobile. The silicone pads 38 capture the one or more tablets 80 or the one or more pills 82 in such a way to render the tablets or pills immobile relative to the transverse axis. Silicone pads 38 not only capture the tablets 80 or pills 82 but also conform somewhat to the shape of the outermost edges of the tablets or pills because of the rubber-like properties of the silicone. The tablets 80 or pills 82 are additionally rendered immobile because of the relatively high friction between them and the silicone material. First and second ratchet rails 30, 32 therefore tend to constrain both longitudinal and lateral motion of tablets 80 and pills 82 while the retaining wall 26m and pill holders 44, 46 constrain the longitudinal motion of tablets 80 and pills 82.

Additionally, the inward movement of first and second ratchet rails 30, 32 will tend to cause a center region of each tablet 80 or pill 82 to become coincident with slit 26e and thereby with longitudinal axis “Y” of device. In other words, the first and second ratchet rails 30, 32 cause the pills or tablets to become lined up along the longitudinal axis of device 10 with the pills or tablets being captured midway between the first and second ratchet rails 30, 32 Because of this, the cutter blade 20 will be aligned with a midline or centerline of each pill or tablet in the row. When tablets 80 or pills 82 are in the correct position and are retained between the first and second ratchet rails 30, 32, the pill holders 44, 46 and retaining wall 26m, the user will move the rail lock assembly to the locked position as described previously herein.

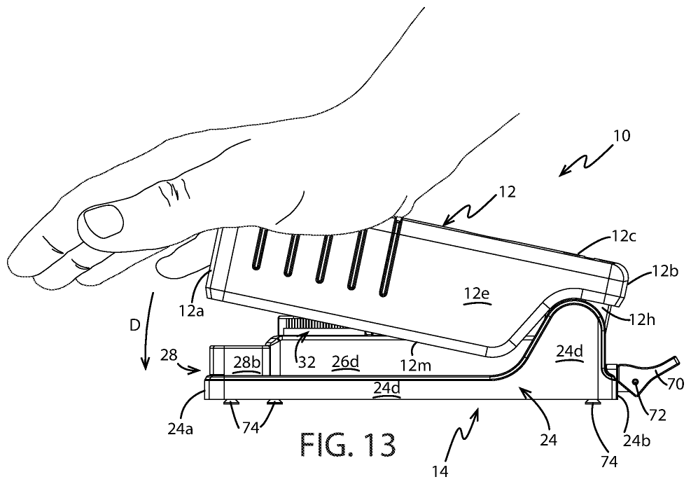

Once the row of tablets 80 or pills 82 are immobile on lower housing 14, a front end of upper housing 12 is pushed downwardly toward lower housing 14 as shown in FIG. 13 in the direction indicated by arrow “D”. This pushing motion causes upper housing 12 to pivot from the open position of FIG. 5 to the closed position FIG. 1 about pivot pin 12j (FIG. 8A) in the direction indicated by arrow “E” in FIG. 10. The downward motion of upper housing 12 will bring cutter blade 20 into contact with the tablets 80 or pills 82 at an angle, as has been previously described herein and will cause cutting edge 20b of cutter blade 20 to progressively slice through each pill 82 or tablet 80 and further more to progressively cut through the row of tablets 80 or pills 82. The rearmost tablet 80 or pill 82 will be cut through first, then the pill or tablet immediately in front of the rearmost tablet or pill will be cut through, then the pill or tablet in front of the second rearmost tablet or pill, etc. This progressively cutting of the pills or tablets using the angled blade substantially prevents the pills or tablets from being crushed as they are cut. Downward movement of the upper housing 12 and therefore of cutter blade 20 is continued until at least the entire lowermost region of cutter blade 20 is received in slit 26e defined in top wall 26e of base 24.

At this point, all of the one or more tablets 80 or pills 82 have been cut in half. The cut tablets 80 or pills 82 may then be removed from pill cutter device 10. This may be accomplished by the user removing brush tool 22 from recessed region 12g of upper housing 12 and using the bristles 22b of brush tool 22 to sweep the cut tablets or pills from top wall 26e and into the chamber 28a of container 28. (The user may first move the rail lock assembly 52 to the unlocked position and then move the first and second ratchet rails 30, 32 laterally apart from each other prior to sweeping the cut tablets or pills into the container 28.)

The above-described loading and cutting steps may be repeated until sufficient tablets or pills have been cut or until container 28 is filled with cut sections of tablets or pills. Container 28 may be lifted out of the depression 24g defined in base 24 in the direction of arrow “G” (FIG. 16). The cut tablets 80 or pills 82 may then be poured out of container 28 for use.

It will be understood that instead of both of the first and second ratchet rails 30, 32 being movable laterally across the top wall 26e of lower housing 14, one of the rails may be locked in place and stationary and only the other rail may move laterally across the top wall 26e. In other examples, one of the rails 30, 32 may be replaced with a fixed wall.

It will be understood that the movement of the first and second ratchet rails 30, 32 laterally across the top wall 26e is motion that is parallel to the longitudinal axis “Y” of the device 10. In other examples, the rails 30, 32 may be oriented parallel to a lateral axis of the device and the blade 20 may likewise be oriented parallel the lateral axis instead of the longitudinal axis. In yet other examples the rails 30, 32 and all associated components above and below the top wall 26e) may be oriented at any other desired angle relative to the longitudinal axis “Y” of the device 10. Rails 30, 32 no matter their orientation relative to the longitudinal axis of the device 10 may move at right angles to their length and the pill holders 44, 46 engaged therewith move in a direction back and forth along the length of the rails.

It will further be understood that the ratchet teeth provided on first and second ratchet rails 30, 32 and on the associated pill holders 44, 46 may be provided in a different location to what is illustrated in the attached figures. For example, the teeth may be provided on an upper surface of the rails 30, 32 and on an interior surface of the pill holders 44, 46 that is opposed to the upper surface of the rails 30, 32.

Rail lock assembly 52 may be provided elsewhere on device from what is illustrated herein. Additionally or alternatively other mechanisms for preventing motion of the rails 30, 32 may be utilized.

Still further, instead of upper housing 12 being pivotally engaged with lower housing 14, upper housing 12 have a blade receiving surface that is oriented parallel to the top wall 26e of lower housing 14 and that blade receiving surface may be maintained in a parallel orientation relative to top wall 26e while upper housing 12 is moved upwardly or downwardly relative to lower housing 14.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A pill cutter device for simultaneously cutting one or more pills comprising:
a lower housing having a top wall adapted to receive one or more pills thereon;
at least one rail extending longitudinally along the top wall; said at least one rail being laterally movable across the top wall in one of a first lateral direction and a second lateral direction; and
a pill holder engaged on the at least one rail, said pill holder being longitudinally movable along the at least one rail.

2. The pill cutter device as defined in claim 1, further comprising:
a retaining wall provided on the top wall, said retaining wall being oriented at right angles to a longitudinal axis of the top wall, wherein the pill holder and retaining wall are adapted to retain the one or more pills longitudinally between them.

3. The pill cutter device as defined in claim 1, wherein the at least one rail comprises:
a first ratchet rail and a second ratchet rail; and wherein the pill cutter device further comprises a linkage extending between the first ratchet rail and the second ratchet rail, and wherein the linkage causes the first ratchet rail and the second ratchet rail to move in unison.

4. The pill cutter device as defined in claim 3, wherein the linkage causes the first ratchet rail and the second ratchet rail to move laterally in unison in one of a first direction toward each other and in a second direction away from each other.

5. The pill cutter device as defined in claim 1, wherein the at least one rail includes a resilient pad provided on a pill contacting surface.

6. The pill cutter device as defined in claim 1, wherein the at least one rail includes a ratchet surface including one or more teeth; and where the pill holder includes at least one tooth that selectively engages the one or more teeth or the ratchet surface and resists longitudinal movement of the pill holder along the at least one rail.

7. The pill cutter device as defined in claim 1, further comprising an upper housing pivotally engaged with the lower housing; and wherein the upper housing includes a blade extending downwardly from an upper wall of the upper housing; and wherein the blade is oriented parallel to a longitudinal axis of the lower housing and at an angle to the top wall of the lower housing.

8. The pill cutter device as defined in claim 7, further comprising a slit defined in top wall of the lower housing; wherein the slit is positioned to align with the blade and to progressively receive at least a portion of the blade therein during a cutting procedure.

9. The pill cutter device as defined in claim 1, further comprising a rail lock assembly that is movable between a locked position and an unlocked position; and when the rail lock assembly is in the locked position, lateral movement of the at least one rail is prevented; and when the rail lock assembly is in the unlocked position, lateral movement of the at least one rail is possible.

10. The pill cutter device as defined in claim 1, further comprising a cut-pill container that is removably engaged with the lower housing, wherein the container has an upper end that is flush with or located a distance vertically below the top wall of the lower housing.

11. The pill cutter device as defined in claim 1, further comprising a brush tool detachably engaged with the pill cutter device; said brush tool being selectively engageable with the pill holder to move the pill holder longitudinally along the at least one rail.

12. The pill cutter device as defined in claim 1, further comprising one or more slots defined in the top wall of the lower housing; and wherein at least a portion of the at least one rail extends through the one or more slots.

13. The pill cutter device as defined in claim 12, wherein the one or more slots are laterally-oriented on the top wall; and wherein the one or more slots limit the lateral travel of the at least one rail across the top wall.

14. The pill cutter device as defined in claim 1, wherein the at least one rail includes:
a first ratchet rail located above an upper surface of the top wall of the lower housing;
a first slide rail located below a lower surface of the top wall of the lower housing; wherein the first ratchet rail and first slide rail are operatively engaged with each other.

15. The pill cutter device as defined in claim 14, wherein the at least one rail further comprises:
a second ratchet rail located above the upper surface of the top wall of the lower housing and spaced laterally from the first ratchet rail;
a second slide rail located below the lower surface of the top wall of the lower housing; wherein the second ratchet rail and second slide rail are operatively engaged with each other; and the second slide rail is laterally spaced from the first slide rail; and
at least one rotatable cam operatively connecting the first slide rail to the second slide rail.

16. The pill cutter device as defined in claim 15, wherein the at least one rotatable cam causes the first ratchet rail and second ratchet rail to move in unison.

17. A method of cutting one or more pills into smaller pill segments comprising:
placing one or more pills onto a surface of a lower housing of a pill cutter device;
moving at least one rail across the surface to contact the one or more pills;
immobilizing the one or more pills, wherein the immobilizing includes contacting the one or more pills with a resilient pad provided on the at least one rail;
aligning a blade on an upper housing of the pill cutter device with a centerline of the one or more pills;
bringing the blade into contact with the one or more pills; and
cutting the one or more pills into smaller pill segments.

18. The method as defined in claim 17, wherein the moving includes:
moving the at least one rail laterally across the surface and at right angles to a longitudinal axis of the pill cutter device; and the method further includes aligning the one or more pills along the longitudinal axis prior to bringing the blade into contact with the one or more pills.

19. The method as defined in claim 18, further comprising:
pivoting the upper housing downwardly toward the lower housing;
orienting the blade at an angle relative to the top wall; and
progressively and sequentially cutting the one or more pills with the angled blade.

20. The method as defined in claim 17, wherein:
moving the at least one rail includes moving a first rail and a second rail laterally across the surface towards one another; and
immobilizing the one or more pills includes capturing the one or more pills between a resilient pad provided on the first rail and a resilient pad provided on the second rail.
